(19) United States
(12) Patent Application Publication
(10) Pub. No.: US 2006/0104202 A1
(43) Pub. Date: May 18, 2006

(54) Rule creation for computer application screening; application error testing

(76) Inventor: Richard Reiner, Toronto (CA)

Correspondence Address: ECKERT SEAMANS CHERIN & MELLOTT, 600 GRANT STREET, 44TH FLOOR, PITTSBURGH, PA, 15219, US

(21) Appl. No.: 10/530,074

(22) PCT Filed: Oct. 1, 2003
(86) PCT No.: PCT/CA03/01507

§ 371 Date: Apr. 1, 2005

Related U.S. Application Data
(60) Provisional application No. 60/415,202, filed on Oct. 2, 2002.

(51) Int. Cl. H04L 12/26

(52) U.S. Cl. 370/230; 370/235

(57) ABSTRACT

To facilitate the creation of rules for screening application layer requests to a computer application, a sample space of application layer requests is grouped according to one or more grouping criteria. Each grouping criterion may be a feature of application layer requests such that each grouping contains application layer requests with a common feature. For example, which the application layer requests follow the hyper-text transport protocol (HTTP), a common feature for some groupings could be a common URI pathname extension. A rule set for an application may be used to expose errors in the application. Test requests are constructed each of which violates at least one of the rules. The test requests are passed to the application to see whether the application throws the expected exceptions.

### BACKGROUND OF THE INVENTION

This invention relates to the facilitation of rule creation for screening requests to a computer application

In computer networks, information is conventionally transmitted in the form of packets. The information flow is typically in the form of a request made to a computer application and a reply by the application to the request. If the packets arrive from an untrusted source, such as the public Internet, there is a risk that they comprise or contain an illegitimate request to the computer application. Such an illegitimate request may constitute an unauthorised attempt to access proprietary information, an unauthorised attempt to alter information, or an attempt to interfere with the normal operations of the application (a so-called “denial of service attack”).

An application on a computer may be shielded from illegitimate requests by a computer firewall which filters packets destined for the application. More particularly, the firewall inspects packets and either passes them to the application or drops them depending upon whether they conform to a set of predefined access rules. Known packet filtering firewalls may apply rules to the packet headers of one or more of the link layer, network layer, and transport layer in order to verify the protocols used.

Another approach to shielding an application from illegitimate requests is to employ a proxy firewall. A proxy firewall acts as the destination for packets arriving through a public network and strips off the overhead from each packet that was used in directing the packet through the public network. With this approach, any attacks using the network overhead of packets are avoided. Known proxy firewalls may also apply rules to verify the application protocol.

Although packet filtering firewalls and proxy firewalls have been effective in screening out many illegitimate requests, successful “attacks” that breach such firewalls still occur. Therefore, there is a need for access rules that allow more effective screening of requests to a computer application.

### SUMMARY OF INVENTION

To facilitate the creation of rules for screening application layer requests to a computer application, a sample space of application layer requests is grouped according to one or more grouping criteria Each grouping criterion may be a feature of application layer requests such that each grouping contains application layer requests with a common feature. For example, where the application layer requests follow the hypertext transport protocol (HTTP), a common feature for some groupings could be a common URI pathname extension.

A rule set for an application may be used to expose errors in the application which may impair the security of the application or the data which the application processes. Test requests are constructed each of which violates at least one of the rules. The test requests are passed to the application to see whether the application throws the expected exceptions.

According to the present invention, there is provided a method for facilitating creation of rules for screening application layer requests, comprising: grouping application layer requests from a sample space of application layer requests by a feature of said requests.

According to another aspect of the invention, there is provided a method of creating a rule set for screening application layer requests, comprising: obtaining a set of data templates applicable to each constituent type of said requests; grouping application layer requests utilising one or more grouping criteria; obtaining a rule set for each requests grouping by: for each type of constituent of said requests, identifying names and associated data elements found in requests of said each requests grouping; for each name: obtaining a sample group of data elements, each data element associated with an instance of said each name; matching said sample group of data elements with a data element template; and binding a rule to said each name based on said matching data template.

According to a further aspect of the invention, there is provided a method for facilitating creation of a rule set for screening Hypertext Protocol (HTTP) requests, comprising: grouping HTTP requests from a sample space of HTTP requests by Universal Resource Indicator (URI) pathname extensions of said requests.

According to another aspect of the invention, there is provided a method for testing for errors in a computer application, comprising: obtaining a rule set for screening illegitimate inputs to an application; constructing test inputs, each test input violating at least one rule of said rule set, passing said test requests to said application; based on responses from said application to said test inputs, determining presence of errors in said application.

Related systems and computer readable media are also provided.

Other features and advantages will become apparent after a review of the following description in conjunction with the drawings.

### BRIEF DESCRIPTION OF THE DRAWINGS

In the figures which describe example embodiments of the invention,

FIGS. 1A, 1B, 1C, and 1D illustrate the contents of example HTTP requests,

FIG. 2 is an example of a portion of a rule template in accordance with this invention in human readable form,

FIG. 3 is a schematic view of a system employing embodiments of this invention,

FIG. 4 is a flow diagram illustrating operation of a portion the system of FIG. 3, and

FIG. 5 is an example of a portion of a rule set in accordance with this invention in human readable form.

### DETAILED DESCRIPTION

Packets transmitted across the Internet comprise a top level link layer, a mid-level network layer, a lower level transport layer, and a low level application layer. Each of the higher layers is, in essence, a packet. Thus, the link layer is a packet with a header and data that comprises a network layer packet and the network layer packet has a header and data that comprises a transport layer packet. The header of the link layer almost invariably indicates that the protocol followed by the packet is the Internet Protocol (IP) (older protocols being now substantially obsolete and/or not in use on the Internet). Where the packet is an IP packet, the network layer is known as an IP datagram. The header of the transport layer will indicate the transport protocol, the Transport Control Protocol (TCP) of the IP being by far the most common transport protocol as it is used for web browsing, e-mail, and web services. (As will be appreciated by those skilled in the art, web services are machine-to-machine interactions whereby one application may make requests of another application).

The data of a transport layer packet comprises the application layer (which is typically distributed across a number of transport layer packets). The port number at the transport layer, and/or the context, indicates the application layer protocol. Where the transport protocol is TCP, while the application layer protocol may be any of various application layer protocols, the most important are hyper-text transfer protocol (HTTP), secure HTTP (HTTPS), file transfer protocol (FTP), and simple mail transfer protocol (SMTP).

Known packet filtering firewalls may apply rules to the packet headers of one or more of the link layer, network layer, and transport layer in order to verify the protocols used. Known proxy firewalls may verify the application protocol. Each rule applied by known packet filtering firewalls and proxy firewalls has a form that may be termed “simple universal”. By way of explanation, a rule specifies a type of element to which it applies. The rule is a simple universal rule if it applies to all elements of the type specified by the rule. As an example, in the rule “All packets must be addressed to destination port number 80”, the element to which the rule applies is a packet. And, since this rule applies to all packets, it is a simple universal rule.

Currently, HTTP (or HTTPS) is used for web browsing and web services. An HTTP request has the following general form:
<Method> <URI> <HTTP version>
<HTTP headers with embedded cookies>
<body of request>
   where “URI” denotes Universal Resource Identifier. The URI is a link to an entity on the web and is commonly a Universal Resource Locator (URL). The URI also includes any URI parameters, which are also known as GET fields. There may be zero or more headers and zero or more cookies in the HTTP request. The body is optional and, if present, may have a URI-encoded format, a form multi-part encoded format, a Simple Object Access Protocol (SOAP) format, or the body may have unstructured content. A body having a URI encoded format or a form multi-part encoded format is written in hyper-text mark-up language (HTML) or extensible HTML (XHTML). A body having a SOAP format is written in extensible mark-up language (XML).

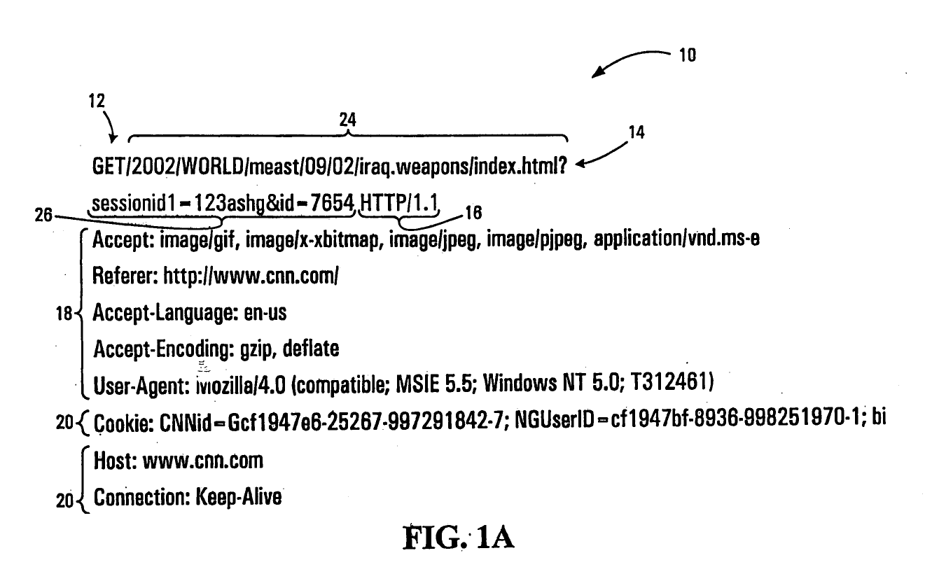

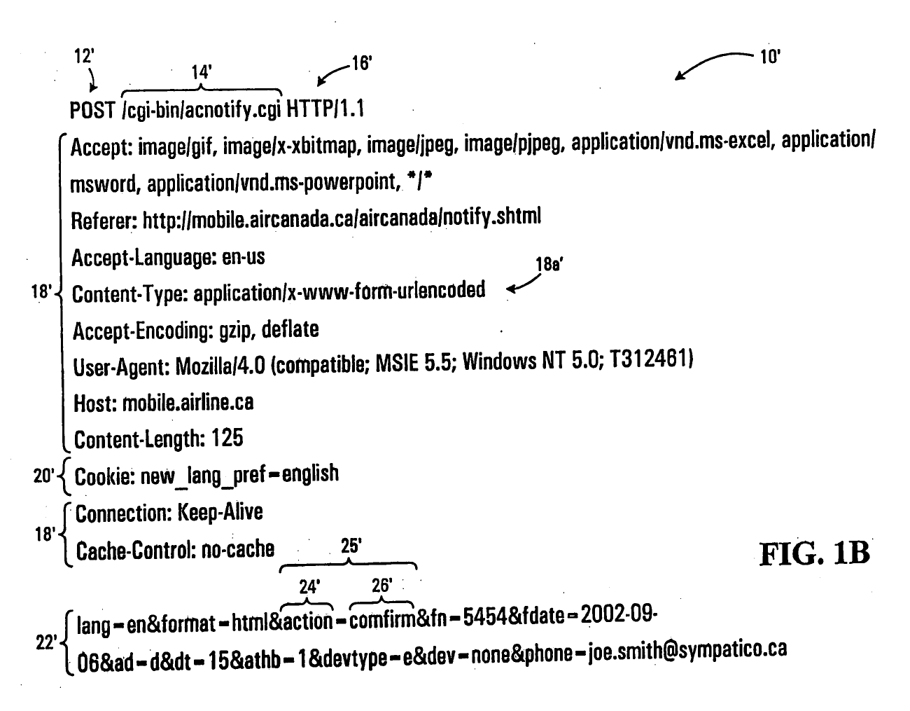

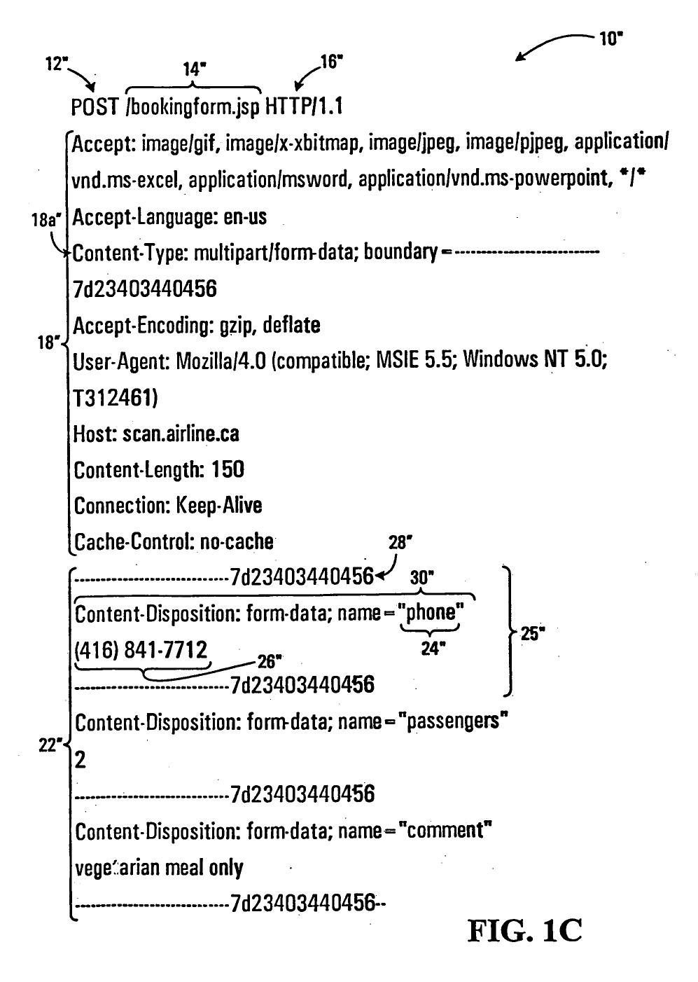

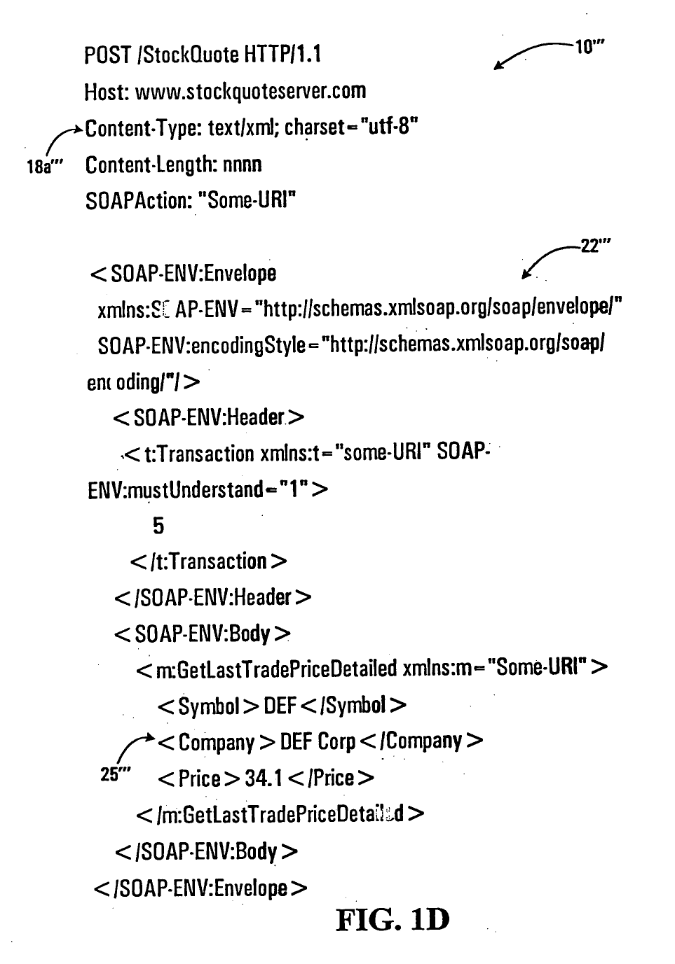

By way of example, turning to FIG. 1A, an HTTP request 10 has the following constituents: a GET Method 12, a URI 14, an HTTP version indicator 16, and headers 18 with embedded cookies 20. This particular HTTP request has no body. The URI is comprised of URL 24 and URI parameter 26.

As will be apparent from FIG. 1A, a URI parameter 26 has the format “name” =“value” (the example HTTP request 10 having two URI parameters). As is typical, the URI parameters identify the user's current session. The headers 18 have the format “name”:“value”. Each cookie has an embedded name and value pair, with each pair being separated by a colon. Thus, cookies 20 have the format: “Cookie”:“name1=value1”; “name2”=“value2”; “name3”=“value3”. . .

FIG. 1B illustrates a second example HTTP request 10′ with a POST Method 12′, a URI 14′ having no URI parameters, an HTTP version indicator 16, and headers 18′ with an embedded cookie 20′. HTTP request 10′ also has a body 22′. The body is comprised of fields 25′, each having a name 24′ and value 26′ pair. Header 18a′ of the request 10′ indicates that the body 22′ has a URL-encoded format, consequently, the name-value pairs are of the form “name”=“value”, with each pair being separated by an ampersand.

The example HTTP request 10″ of FIG. 1C has the following constituents: a Method 12″, URI 14″, HTTP version indicator 16″, headers 18″, and fields 25″ of body 22″. It will be noted that there are no cookies embedded in the headers. Header 18a″ indicates that the body 22″ has a multi-part form encoded formal. With a multi-part form format, the fields of the body are known as parts. Header 18a″ specifies a part boundary 28″ which delineates each part. A part boundary is followed by one or more headers 30″ incorporating the name 24″ of the data field, followed by the field value 26″.

The example HTTP request 10′″ of FIG. 1D has a header 18a′″ indicating the body 22′″ has a SOAP format, such that the constituent elements 25′″ of the body comprise XML elements, their attributes, and data objects according to the specification of the SOAP message format.

There is a possibility of an illegitimate request generator (which may be a human hacker or a machine) employing constituents of the actual payload data (the application layer) of a packet in launching an attack on an application. Thus, an attack could use constituents of an HTTP request To frustrate such attacks, it is contemplated to create screening rules to constituents of each HTTP request.

The approach to the creation of HTTP screening rules is to initially consider the nature of the computer application, or applications, that are to be protected by the screening rules. A rule developer may have only general knowledge of common types of applications. Or the developer may have knowledge of the general domain of the application(s) to be screened. Or the developer may have specific knowledge of the application(s). Knowledge of the nature of the data elements in applications (or in a type of application) may be gained from the functional specifications for these (or sample ones of these) applications; based on this nature, rule templates may be written. Thus, where the rule developer is working from general knowledge of common types of applications, he/she may write rule templates for commonly found data elements. Where the rule developer is working with knowledge of the general domain of the application(s) to be screened, he/she may write rule templates for domain-specific data elements. And where the rule developer is working with knowledge of the specific application(s) to be screened, he/she may write rule templates for application-specific data elements.

For example, web applications involving on-line shopping or a registration process inevitably at some point serve up a form for a user to fill out and submit. A filled out form will be embodied in a request to the application in URL-encoded format or multi-part form encoded format. The fields of the body will have name data, address data, zip code (or postal code) data, and typically a telephone number. The data elements of these fields may be considered to be commonly found data elements.

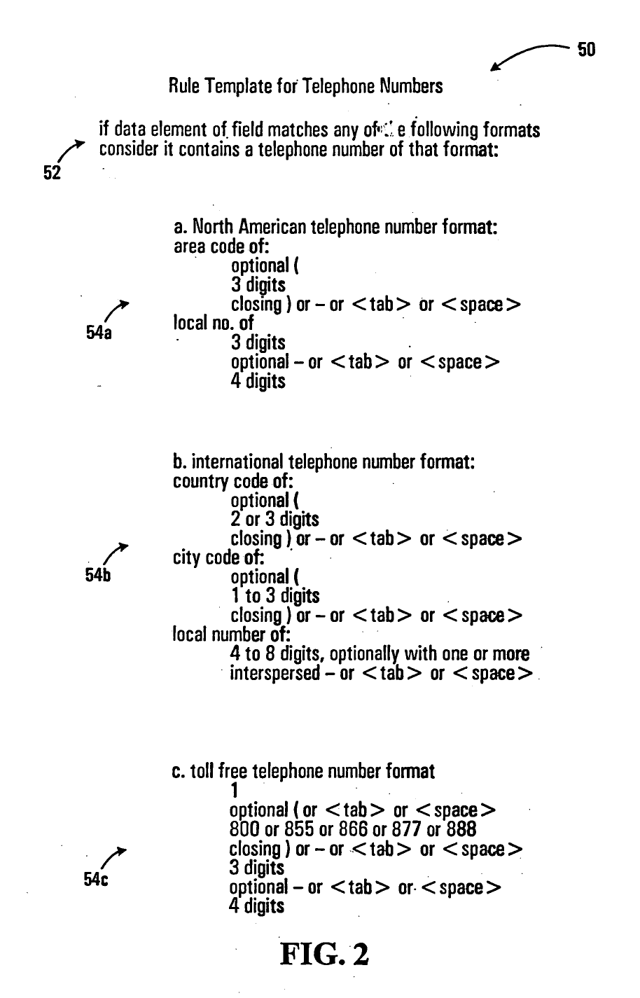

Taking a telephone number as an example, the rule developer may write a rule template for fields containing such numbers. A sample of such a rule template, written in human readable form, is illustrated out in FIG. 2. (In practice, rule templates will be written more symbolically, such as by using a pattern language known as Regular Expressions. Turning to FIG. 2, a rule template 50 has a statement 52 of its application followed by a series of data element templates: data element template 54a for North American format telephone numbers; data element template 54b for international format telephone numbers; and data element template 54c for toll free telephone numbers.

If the domain of the application(s) to be screened is known to be that of product catalogs, then there will be rule templates written for data elements specific to product catalogs, such as Universal Pricing Codes (UPC). Similarly, for travel booking type applications, there will be rule templates written for data elements specific to travel booking, such as international airport codes. If the nature of the specific application to be screened is known, there will be rule templates specific to that application, such as the necessary format for a User ID.

Over and above any of the foregoing rule templates that may be written, the rule developer will write abstract rule templates for data elements not matched by any of the foregoing more specific templates. (Thus, the statement of application of the abstract rule template is that they are for data elements not otherwise matched). The data element templates for this rule template may include:
A numeric data template
An alphabetic data template
An alphanumeric data template
A printable-ASCII characterstring template
A general ASCII characterstring template
A UTF-8 characterstring template
A UCS-16 characterstring template

These data templates have been ordered from more specific to least specific, for reasons that will become apparent hereinafter. Indeed, more generally, for any rule template, where the format of some of the data templates of the rule template are more specific than others, the data templates are ordered from most specific to least specific.

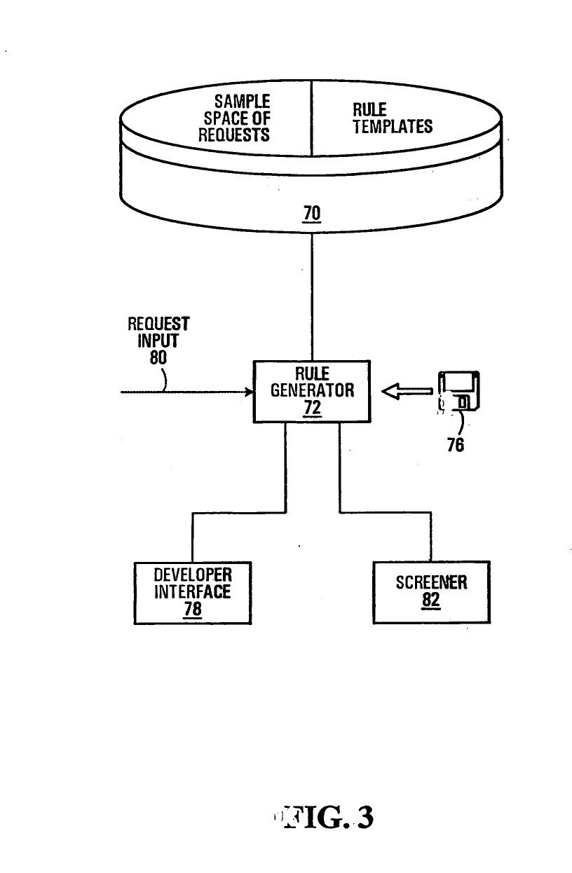

With reference to FIG. 3, rule templates for domains or for commonly found data elements may be written in advance and stored in a database 70 indexed in some appropriate manner. The database may be connected to a rule generator 72 which may be a general purpose computer programmed with rule generation software embodied in a computer readable medium 76, such as a computer diskette, a read-only memory (ROM) chip, or a file downloaded from a remote source. The rule generator is also connected or communication with a developer interface 78 and with a screener 82; the rule generator may receive data over communication line 80. Database 70 stores a sample space of HTTP requests intended for one or more computer applications to be screened. The requests of the sample space are either part of computer packets addressed to the application(s) requiring screening rules or have been stripped out of such computer packets. The requests of the sample space may be received on communication line 80 and accumulated by the database into the sample space. The sample space of requests is assumed to represent legitimate uses of the one or more applications. Thus, the sample space is typically generated before requests are received from an untrusted source.

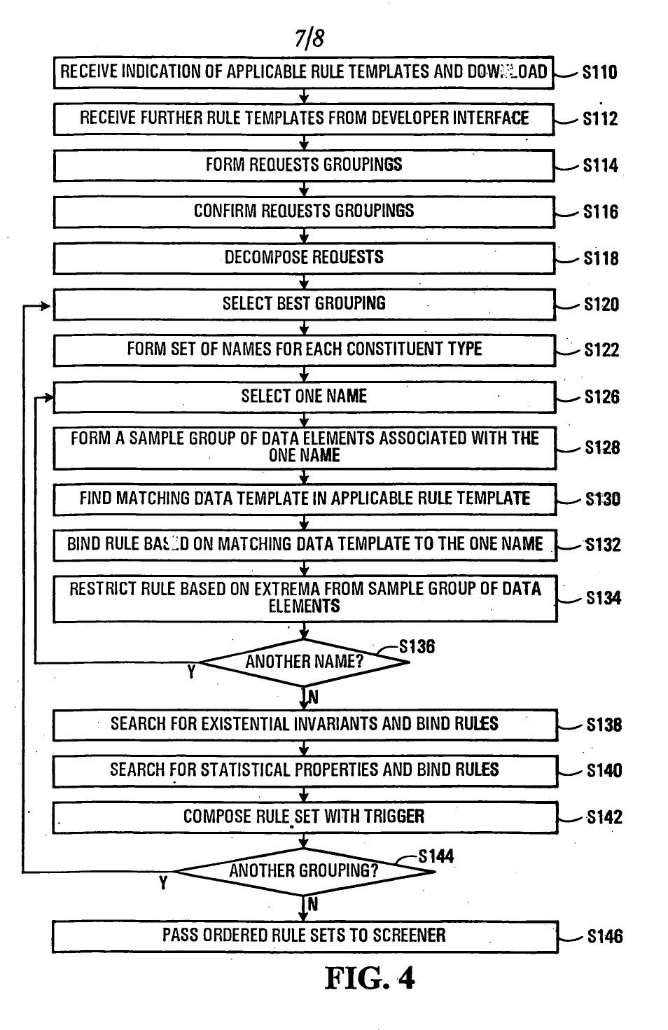

With reference to FIG. 4, which illustrates the operation of the rule generator 72, in order to create rules for the application(s) requiring screening, a rule developer, through interface 78, may indicate to the rule generator 72 appropriate rule templates in the database (S110). Additionally, the developer may construct further rule templates that are specific to the application(s) to be screened and pass these to the rule generator through interface 78 (S112).

The rule generator 72 then groups the HTTP requests (S114). Grouping is accomplished in a hierarchical fashion, that is, initially HTTP requests meeting a first criterion are grouped. The residue of HTTP requests not meeting the first criterion is then grouped according to a second criterion and the residue of that grouping is grouped by a third criterion, and so on. The grouping criteria are applied in the order of their ability to group the HTTP requests in a way that promotes the matching of data elements in a group of requests with data templates in the rule templates. In HTTP requests, each data element is typically associated with a name (as described hereinbefore in conjunction with FIGS. 1A to 1D). And in any one application, although different parts of the application will be addressed with different URIs, any unique name in the application will be associated with data elements having a set format. Thus, if the groupings can be such that there are plural instances of a unique name, there will be a like plurality of instances of data elements having the same format, thus promoting the matching with a data template. The hierarchical grouping process therefore results in groupings that are ordered from those having a higher probability of producing matchings to those with a lower probability of producing matchings.

The requests within the sample space are first formed into collections such that each collection comprises all the requests for a given unique URL. These collections are then grouped in order to promote accuracy in the generation of rules. All further grouping operations act upon these collections.

In order to promote rapid processing, grouping of requests is first performed on the basis of properties of requests which are observable solely through examination of the unique request URI corresponding to each collection, i.e., without examination of the Headers, Cookies, body, Method or HTTP version of requests within the collection.

The first criteria for grouping requests may be type indicators, such as the filename extension within the URI pathname. Thus, for example, the following (highest order) groupings may be formed:
a grouping for HTTP requests with URIs having known “image” filetypes, which are represented by filename extensions including extensions including “.gif”, “jpg”, “.jpeg”, “.png”;
a grouping for HTTP requests with URIs having known “HTML/CSS” filetypes, which are represented by filename extensions including “.htm”, “.html”, “.css”;
a grouping for HTTP requests with URIs having known “client-side script” filetypes, which are represented by filename extensions including “.js”;
a grouping for HTTP requests with URIs having known “dynamic content” filetypes, which are represented by filename extensions including “.jsp”, “.asp”, “.pl”, “.php”; and
a grouping for HTTP requests with URIs having any filetype represented by an otherwise unrecognized filename extension occurring for the URI of more than a threshold number of HTTP requests within the sample space.

For the residue of requests not grouped by application of the first criteria, a second order grouping criteria is applied. This second criteria is the directory name prefix portions of the unique URI pathnames. Thus, for example, the following groupings may be formed:
a grouping for HTTP requests having URIs with the prefix URI pathname “/images/”;
a grouping for HTTP requests having URIs with the prefix URI pathname “/scripts”; and
a grouping for HTTP requests having URIs with any pathname prefix encountered in more than a threshold number of the residual HTTP requests.

Optionally, the residue of requests not grouped by either the first or the second criteria may be grouped according to patterns found within the URI of the requests. For example, all URIs with the substring “online/banking/application” may be grouped together. Any residue may be grouped according to the length of the URI in the remaining HTTP requests. For example, all URIs over 1000 characters in length may be grouped together.

For any residue remaining, the collection of requests for each unique URI is then examined, and invariants (i.e. properties that are invariant across all the requests in any one collection) are sought. Additional grouping of collections may then be performed on the basis of these invariants. These invariants may be sought first in the content type of the body of the requests, then in the size of the requests, then in the Method of the requests, and lastly in any other properties of the requests. For example, the following groupings may be formed based on the content type:
a grouping for collections of requests, where the requests of each of the collections have an invariant content-type “application/x-www-form-urlencoded”;
a grouping for collections of requests, where the requests of each of the collections have an invariant known content-type representing HTML form submissions, including “application/x-www-form-urlencoded” and “multipart/form-data”;
a grouping for collections of requests, where the requests of each of the collections have an invariant unknown content-type, where the number of requests represented in the collections exceed a threshold number of requests within the sample space.

For any residue, additional grouping may then be performed on the basis of the request headers. For example, the following groupings may be formed based on the request headers:
a grouping for collections of requests, where the requests of each of the collections have a Transfer Encoding (“TE”) header and where the value for the TE header is invariant (i.e., the same) for all requests in the grouping;
a grouping for collections of requests, where the requests of each of the collections have a “User-Agent” header and where the value for the User-Agent header is invariant for all requests in the grouping;
a grouping for collections of requests, where the requests of each of the collections have an “Accept-Language” header and where the value for the Accept-Language header is invariant for all requests in the grouping;
a grouping for collections of requests, where the requests of each of the collections have an invariant header value for any given header where the number of requests represented in the collections exceed a threshold number of requests within the sample space.

For any residue, the following groups may be formed based on request size:
a grouping for collections of requests, where the requests of each of the collections have an invariant body size over 1000 bytes;
a grouping for collections of requests, where the requests of each of the collections have over 500 bytes of headers.

For any residue, the following groupings may be formed based on the request Method:
a grouping for collections of requests, where the requests of each of the collections have a PUT Method;
a grouping for collections of requests, where the requests of each of the collections have a HEAD or GET Method.

Lastly, any remaining reside may be grouped based on any other invariant properties of the requests within each collection. This is the lowest order grouping critera.

The ruler generator 72 may then present the groupings to the developer interface 78 in order to allow the rule developer to break any grouping apart to form two or more groupings or coalesce any two or more groupings into a grouping (S116).

The requests within each grouping are then decomposed into their constituents (S118). With HTTP requests, these constituents include: Method, URI, GET fields (URI parameters), HTTP version, Headers, Cookies, url-encoded POST fields, form multipart encoded POST fields, and SOAP elements.

Next, for each grouping (S120, S144), for each type of constituent (i.e., GET fields, Headers, Coolies, etc.), the rule generator 72 forms a set of all constituent names (i.e., a set of all constituent names appearing in one or more requests within the grouping) (S122). For each name in the set (S126, S136), the sample group of associated data elements is formed where each data element is associated with an instance of the name (S128).

The data templates of applicable ones of the selected rule templates are then applied to each sample group of data elements in order to find a matching data template (S130). For example, the FIG. 2 rule template for telephone numbers is only potentially applicable to a data element in a body of a request (i.e., in a URI-encoded POST field, a multi-art encoded POST field, or a SOAP element) or in a GET field (URI parameter). Therefore, this rule template is applicable only where the HTTP constituent type is a URL-encoded field, a multipart-encoded field, or a SOAP element in the body or the URI parameters.

In the situation where a rule template has data element templates of greater to lesser specificity, a data element that matches a data element template of lesser specificity may also match a data element template of greater specificity. As aforenoted, the data element templates of such a rule template are organised from greater to lesser specificity in a rule template. With such an organisation, the rule generator 72 may search for a matching data element template beginning with templates of greater specificity and terminate the search upon finding the first data element template that matches the format of the sample group of data elements.

It will be recollected that in any one computer application any unique name in the application will be associated with data elements having the same format. Thus, a name in a set of names in a group of requests will normally be associated with data element having an identical format. There is also the possibility of the same name being used in one group of requests in association with data elements of different formats (normally due to the identical name having been used in different computer applications). In such a situation, a sample group of data elements might only be declared to match one of the data element templates in the aforedescribed abstract rule template. Such matches may be flagged to the rule developer (via interface 78) to allow a modification of the request groups in order to improve matching.

When a sample group of data elements matches a data element template, the corresponding constituent type name is bound to a rule requiring that each instance of the name of that constituent type have an associated data element according to the matching data element template (S132). It will be appreciated that such a rule is a simple universal rule in that it applies to all elements of that constituent type.

By way of example, it may be that a sample group of data elements associated with the name “telno” in the body of the request matched the North American telephone number format of (xxx) xxx-xxxx. In such case, a rule would be created that states: For all requests, where a body name is “telno”, the associated data element must have the format (xxx) xxx-xxxx.

The bound simple universal rule may be restricted in the following ways:
The rule may be assigned a minimum data value length (in characters or bytes) and a maximum data value length (in characters or bytes), based on the extrema in the sample group of data elements from which it was generated;
when the data element values are of numeric type, the rule may be assigned a minimum numeric data value and a maximum numeric data value, based on the extreme in the sample group of data elements from which it was generated (S134).

The rule generator 72 may then examine each grouping of HTTP requests for existential invariants. For example, the rule generator may look for named elements of any type which never fail to exist (i.e., a simple existential invariant), and/or element types which always exist in a specific number (i.e., a complex existential invariant). For each existential invariant, a rule stipulating a requirement for the existence of that entity (or that number of entities) is bound to the grouping, creating a bound existential rule (S138). For example, the rule generator may note that every request in a grouping of HTTP requests has a Cookie named “SessionID”. In such instance, the rule generator may establish a simple existential rule requiring a Cookie named “SessionID” for any HTTP request falling into that grouping (i.e., any HTTP request having the URI, header, or other feature that forms the basis for the grouping). Or the rule generator may note that every request in a grouping has between three and five POST fields with numeric values. In such instance, the rule generator may establish a complex existential rule requiring between three and five POST fields with numeric values for any HTTP request falling into that grouping

Next, each grouping of HTTP requests may be examined for statistical properties. For each statistical invariant, a rule stipulating a requirement for that statistical property is bound to the URI grouping, creating a bound statistical rule (S140). For example, a statistical rule might be “No more than 5% of the POST fields may have blank (empty) values”.

Finally, the resulting bound rules (of all types, i.e. simple universal bound rules, existential bound rules, statistical bound rules) for each group are composed into a complete rule set. The rule set for a grouping has rules that are applicable for any subsequent HTTP requests that have a feature which is the same as the feature that formed the basis for the group. For example, a rule set may result from a group formed from HTTP requests with URIs having the filename extension “.gif”. In such case, this rule set is applicable for any subsequent HTTP request with a URI having the filename extension “.gif”. Thus, this feature is a “trigger” for the rule set. Hence, the common feature that formed the basis for each grouping is formed into a trigger condition for a rule set, and each rule (of each type) bound to the grouping becomes a condition that is added to the rule set (S142).

It will be apparent from the foregoing description of the manner in which groupings are formed that an HTTP request could satisfy the trigger condition of more than one rule set. However, as aforedescribed, the groupings are hierarchically ordered to generally progress from groupings having a higher probability of producing matchings to those with a lower probability of producing matchings. For processing efficiency, it is generally appropriate that any one request is screened by only one rule set. Thus, the rule sets are ordered in the same order in which the groupings are ordered. In consequence, screener 82, on receiving a request, may search for a trigger condition satisfied by the request, beginning with higher order rule sets (which will have a higher probability of producing matchings). The first rule set in the ordered list of rule sets that is found to have a trigger condition which is satisfied by the request is the rule set which is applied to the request.

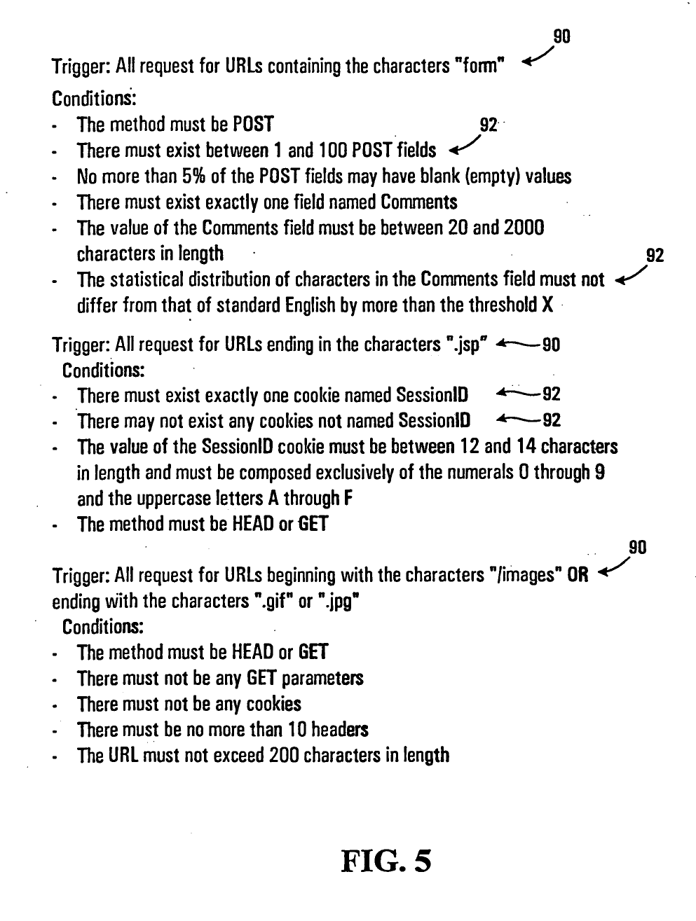

FIG. 5 illustrates a portion of an example rule set, expressed in human readable form. (In practice, rules for requests are typically stored in a table and may be symbolically expressed in a manner allowing finer distinctions than can conveniently be expressed in human readable form.) Turning to FIG. 5, a trigger 90 has a number of conditions 92 associated with it. Each condition is one of the rules bound to the group of HTTP requests that was established based on the URI feature that comprises trigger 90.

The ordered rule sets may then be passed to screener 82 for screening subsequent requests to the application(s) (S146). Optionally, these subsequent HTTP requests may be stored to augment the sample space of requests in database 70. In such case, the rule generator 72 may later process this larger sample space of requests in an attempt to generate improved rule sets.

Any rule set for a computer application developed for the purpose of excluding illegitimate requests (inputs) to the application may be used to expose errors in the application. More particularly, errors in an application may be exposed by passing special “test” requests to the application. Each test request purposely violates one or more of the rules in a rule set for the application. The reaction of the application(s) to the test requests is then be observed to ensure the result is that the application(s) throw expected exceptions in the face of the test requests. Where an application does not throw an expected exception, this indicates an error in the software code for the application.

A rule set may be developed from a consideration of documentation for the application. For example, a rule set may result from rule templates developed by a rule developer with reference to the functional specification for the application, or a rule set may be developed with reference to a functional specification of an earlier version of the application. As will be appreciated by those skilled in the art, a functional specification for a computer application provides the basis for the development of a technical specification for the application. The software code for the application is then written based on the technical specification. A software developer may make an error in moving from the functional specification to the technical specification, or in moving from the technical specification to the software code. The rules that are based on the functional specification of the application assume the application is written as it was envisaged in the functional specification. In consequence, if there was an error in coding, this error may be exposed due to the application not behaving as expected when handling a test request.

As aforedescribed, a rule set may also be developed from a sample space of requests to the application. Such a rule set is assumed to characterise valid requests to the application and, as such, may be used to expose errors.

Each test request includes a violation of at least one property attributed to the objects within a request. Such properties may take the form of stipulations regarding the numeric range of value of objects; stipulations regarding the length (in characters or bytes) of the name or value of objects; or stipulations regarding the format or pattern of the name or value of objects. Thus, test requests may be constructed by constructing a request containing objects with numerical values being outside the range stipulated by a rule; by constructing a request containing objects with a name or a value having a length (in characters or bytes) outside the range stipulated by a rule; or by constructing a request containing objects with a name or a value failing to match a pattern stipulated by a rule.

A test request may be based on a rule of universal form. Such a test request is created from a universal rule describing allowed access to the application. The request is constructed such that the trigger condition of the universal rule is satisfied but the property specified as universally present in objects of a certain type by the universal rule fails to be present in one or more objects of that type.

A test request may also be based on a rule of simple existential form. Such a test request may be created from a simple existential rule describing allowed access to the application by constructing a request to the application which satisfies the trigger condition of the simple existential rule, but wherein the element of a certain type specified as necessarily present by the simple existential rule is absent.

A test request may also be based on a rule of complex existential form. Such a test request may be created from a complex existential rule describing allowed access to the application by constructing a request to the application which satisfies the trigger condition of the complex existential rule, but wherein the element(s) of a certain type specified as necessarily present in a specified number or quantity by the complex existential rule is/are present in a different number or quantity.

A test request may be based on a rule of complex universal form. Such a test request may be created from a complex universal rule describing allowed access to the application. The test request to the application is constructed to satisfy the trigger condition of the complex universal rule, but fails to meet the requirement of the rule for a quasi-universal property in objects of a certain type. (The quasi-universal property may, for example, be one that is specified to be present in all but N of objects of a certain type, or present in m% of such objects.)

A test request may be based on a rule of statistical form. Such a test request may be created from a statistical rule describing allowed access to the application by constructing a request to the application which satisfies the trigger condition of the statistical rule, but wherein the statistical property specified by the statistical rule to objects of a certain type within the request fails to obtain with respect to the objects of that type within the test request.

The test requests may be constructed by a rule developer through the developer interface 78, or by the rule generator 72 (acting as an application tester) and passed directly to the application. The response of the application may be received and analysed by the rule developer or rule generator.

Once an error is exposed, it may be corrected.

Although the invention has been described in conjunction with requests that follow the HTTP protocol, it will be apparent that the teachings of the invention have application to requests that follow any other suitable protocol.

Other modifications will be apparent to those skilled in the art and, therefore, the invention is defined in the claims.

1. A method for facilitating creation of rules for screening application layer requests, comprising:
grouping application layer requests from a sample space of application layer requests by a feature of said requests.

2. The method of claim 1 wherein said feature is a segment of a destination address indicator.

3. The method of claim 2 wherein said application layer requests are Hypertext Protocol (HTTP) requests and said destination address indicator is a Universal Resource Indicator (URI).

4. The method of claim 3 wherein said segment of said URI is a URI pathname extension.

5. The method of claim 4 wherein URI pathname extensions used for said grouping are pre-determined.

6. The method of claim 4 wherein some URI pathname extensions used for said grouping are pre-determined and each one of others is determined as a URI pathname extension used in the URI of a threshold number of said requests.

7. The method of claim 4 further comprising, for a residue of HTTP requests not grouped by said grouping, grouping requests of said residue by directory name prefix portions of URI pathnames of said residue.

8. The method of claim 7 wherein said directory name prefix portions used for said grouping are pre-determined.

9. The method of claim 7 wherein some of said directory name prefix portions used for said grouping are pre-determined and each one of others is determined as a directory name prefix portion used in the URI of a threshold number of said requests.

10. The method of claim 7 further comprising, for a second residue of HTTP requests not yet grouped, grouping requests of said second residue by string patterns within URI pathnames of said second residue.

11. The method of claim 10 further comprising, for a third residue of HTTP requests not yet grouped, grouping a sub-set of requests of said third residue, each request of said sub-set having a common property.

12. The method of claim 11 wherein said common property is a pre-determined content-type.

13. The method of claim 11 wherein said common property is one of a pre-determined content-type and a content-type used in a threshold number of said sub-set of requests.

14. The method of claim 1 further comprising:
obtaining a set of data templates applicable to each constituent type of said requests;
obtaining a rule set for each requests grouping by:
for each type of constituent of said requests, identifying names and associated data elements found in requests of said each requests grouping;
for each name:
obtaining a sample group of data elements, each data element associated with an instance of said each name;
matching said sample group of data elements with a data element template; and
binding a rule to said each name based on said matching data template.

15. The method of claim 14 further comprising:
for each name, determining a length of a longest data element in said set of data elements and binding a further rule to said each name stipulating a maximum permissible length of a data element as said length.

16. The method of claim 14 wherein, where said data elements in said set of data elements are numeric, determining a value of a largest valued data element in said set of data elements and a value of a smallest valued data element in said set of data elements and binding a further rule to said each name stipulating a maximum permissible value of a data element based on said value of said largest valued data element and a minimum permissible value based on said value of said smallest valued data element.

17. The method of claim 14 further comprising, for each requests grouping, searching for an element that is present in each request of said each request grouping and, on finding a given element that is present in each request of said each requests grouping, establishing an existential rule for said each requests grouping requiring the existence of said given element.

18. The method of claim 17 wherein, if said given element is found to be present in each request of said each requests grouping in at least a given number of instantiations, said existential rule for said each requests grouping is established to require the existence of said given element in said minimum number of instantiations.

19. The method of claim 14 further comprising, for each requests grouping, determining a statistical measure of a property of requests in said requests grouping and establishing a statistical rule for said each requests grouping based on said statistical measure.

20. The method of claim 14 further comprising, for each requests grouping, establishing a trigger for said rule set, said trigger comprising a feature by way of which said each requests grouping was formed.

21. A method of creating a rule set for screening application layer requests, comprising:
obtaining a set of data templates applicable to each constituent type of said requests;
grouping application layer requests utilising one or more grouping criteria;
obtaining a rule set for each requests grouping by:
for each type of constituent of said requests, identifying names and associated data elements found in requests of said each requests grouping;
for each name:
obtaining a sample group of data elements, each data element associated with an instance of said each name;
matching said sample group of data elements with a data element template; and
binding a rule to said each name based on said matching data template.

22. A method for facilitating creation of a rule set for screening Hypertext Protocol (HTTP) requests, comprising:
grouping HTTP requests from a sample space of HTTP requests by Universal Resource Indicator (URI) pathname extensions of said requests.

23. A system for facilitating creation of rules for screening application layer requests, comprising:
a database for storing a sample space of application layer requests; and
a rule generator for grouping application layer requests from said sample space of application layer requests by a feature of said requests.

24. A computer readable medium containing computer executable instructions which, when loaded to a processor, adapt said processor to:
group application layer requests from a sample space of application layer requests by a feature of said requests.

25. A system for creating a rule set for screening application layer requests, comprising:
means for obtaining a set of data templates applicable to each constituent type of said requests;
means for grouping application layer requests utilising one or more grouping criteria;
means for obtaining a rule set for each requests grouping by:
for each type of constituent of said requests, identifying names and associated data elements found in requests of said each requests grouping;
for each name:
obtaining a sample group of data elements, each data element associated with an instance of said each name;
matching said sample group of data elements with a data element template; and
binding a rule to said each name based on said matching data template.

26. A computer readable medium containing computer executable instructions which, when loaded to a processor, adapt said processor to:
obtain a set of data templates applicable to each constituent type of said requests;
group application layer requests utilising one or more grouping criteria;
obtain a rule set for each requests grouping by:
for each type of constituent of said requests, identifying names and associated data elements found in requests of said each requests grouping;
for each name:
obtaining a sample group of data elements, each data element associated with an instance of said each name;
matching said sample group of data elements with a data element template; and
binding a rule to said each name based on said matching data template.

27-31. (canceled)
